(19) United States
(12) Patent Application Publication
(10) Pub. No.: US 2024/0005226 A1
(43) Pub. Date: Jan. 4, 2024

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventor: Yu NAGATA, Chofu-shi (JP)

(21) Appl. No.: 18/344,936

(22) Filed: Jun. 30, 2023

(30) Foreign Application Priority Data
Jul. 4, 2022 (JP) 2022-107943

(51) Int. Cl. G06Q 10/0631

(52) U.S. Cl. CPC G06Q 10/0631

(57) ABSTRACT

An information processing apparatus automatically creates an operation plan for an on-demand bus. The information processing apparatus disclosed has a controller configured to set the stop time length of the on-demand bus at a first pick-up and drop-off location at which a first user in a wheelchair is to be picked up or dropped off longer than a second pick-up and drop-off location at which a user other than the first user is to be picked up or dropped off. The controller creates the operation plan for the on-demand bus based on the stop time lengths set as above.

### CROSS REFERENCE TO THE RELATED APPLICATION

This application claims the benefit of Japanese Patent Application No. 2022-107943, filed on Jul. 4, 2022, which is hereby incorporated by reference herein in its entirety.

### BACKGROUND

### Technical Field

The present disclosure relates to an information processing apparatus and an information processing method.

### Description of the Related Art

It is known in the art related to a bus provided with a wheelchair space to display the vacancy status of the wheelchair space (e.g. vacant/used) on a signage device provided on the bus. (see, for example, Patent Literature 1 in the citation list below).

### CITATION LIST

### Patent Literature

Patent Literature 1: Japanese Patent Application Laid-Open No. 2021-009452.

### SUMMARY

An object of this disclosure is to provide a technology that can improve the convenience of people in a wheelchair when using an on-demand bus.

In one aspect of the present disclosure, there is provided an information processing apparatus configured to automatically create an operation plan for an on-demand bus. The information processing apparatus may include, in an exemplary mode, a controller including at least one processor configured to create an operation plan for an on-demand bus in which the stop time length at a pick-up and drop-off location at which a first user in a wheelchair is to be picked up or dropped off is set longer than the stop time length at a pick-up and drop-off location at which a user other than the first user is to be picked up or dropped off.

In another aspect of the present disclosure, there is provided an information processing method for automatically creating an operation plan for an on-demand bus. The information processing method may include creating, by a computer, an operation plan for an on-demand bus in which the stop time length at a pick-up and drop-off location at which a first user in a wheelchair is to be picked up or dropped off is set longer than the stop time length at a pick-up and drop-off location at which a user other than the first user is to be picked up or dropped off.

In another aspect of the present disclosure, there is also provided an information processing program configured to cause a computer to implement the above-described information processing method or a non-transitory storage medium storing such an information processing program in a computer-readable manner.

According to the present disclosure, there is provided a technology that can improve the convenience of people in a wheelchair when using an on-demand bus.

### BRIEF DESCRIPTION OF THE DRAWINGS

FIG. 1 is a diagram illustrating the general configuration of an on-demand bus system according to an embodiment.

FIG. 2 is a diagram illustrating exemplary hardware configurations of an on-vehicle apparatus, a server apparatus, and a user's terminal included in the on-demand bus system according to the embodiment.

FIG. 3 is a block diagram illustrating an exemplary functional configuration of the server apparatus according to the embodiment.

FIG. 4 illustrates an example of information stored in a user management database.

FIG. 5 illustrates an example of information stored in a request management database.

FIG. 6 illustrates an example of information stored in an operation management database.

FIG. 7 illustrates an example of a first web page displayed on the browser of a user's terminal.

FIG. 8 illustrates an example of a second web page displayed on the browser of the user's terminal.

FIG. 9 illustrates an example of a third web page displayed on the browser of the user's terminal.

FIG. 10 illustrates an example of a fourth web page displayed on the browser of the user's terminal.

FIG. 11 illustrates an example of a fifth web page displayed on the browser of the user's terminal.

FIG. 12 illustrates an example of a sixth web page displayed on the browser of the user's terminal.

FIG. 13 is a first flow chart of a processing routine executed in the server apparatus according to the embodiment to determine pick-up and drop-off locations for a user.

FIG. 14 is a second flow chart of the processing routine executed in the server apparatus according to the embodiment to determine pick-up and drop-off locations for the user.

FIG. 15 is a flow chart of a processing routine executed in the server apparatus to determine the stop time lengths at the pick-up and drop-off locations.

FIG. 16 is a block diagram illustrating an exemplary functional configuration of the server apparatus according to a modification.

FIG. 17 illustrates an example of information stored in a facility information database according to the modification.

FIG. 18 illustrates an example of a seventh web page displayed on the browser of the user's terminal.

FIG. 19 is a first flow chart of a processing routine executed in the server apparatus according to the modification to determine pick-up and drop-off locations for the user.

FIG. 20 is a second flow chart of the processing routine executed in the server apparatus according to the modification to determine pick-up and drop-off locations for the user.

FIG. 21 is a third flow chart of the processing routine executed in the server apparatus according to the modification to determine pick-up and drop-off locations for the user.

### DESCRIPTION OF THE EMBODIMENTS

On-demand buses have become widespread recently. The use of autonomous vehicles capable of travelling by autonomous driving as on-demand buses is being considered in areas where people cannot conveniently use public transportation. Operation plans or schedules of on-demand buses are created according to user requests for a ride on an on-demand bus. An operation plan for an on-demand bus contains information on the pick-up and drop-off locations, the expected arrival times at the pick-up and drop-off locations, and the length of stop times at the respective pick-up and drop-off locations. The pick-up and drop-off locations, the expected arrival times at the pick-up and drop-off locations, and the stop time lengths at the pick-up and drop-off locations are determined according to user requests for a ride.

There may be cases where a user in a wheelchair, who will also be referred to as a “first user”, uses the on-demand bus service. The time it takes for the first user to board or exit an on-demand bus tends to be longer than for the other users, such as able-bodied users, who will also be referred to as “second users”. In particular, in the case where the on-demand bus is an autonomous vehicle, there may not be a crew on the on-demand bus to help the first user board or exit the on-demand bus. Then, the time it takes for the first user to board or exit the on-demand bus can be still longer. If the stop time length at the pick-up and drop-off location for the first users, which will also be referred to as “first pick-up and drop-off locations”, is set equal to the stop time length at the pick-up and drop-off locations for the second users, which will also be referred to as “second pick-up and drop-off locations”, the first users may be unsettled when boarding or exiting the on-demand bus, and the operation of the on-demand bus may be delayed from the schedule in the operation plan. In consequence, the convenience of the first users can be deteriorated.

To address the above problem, the information processing apparatus disclosed herein has a controller configured to create an operation plan for an on-demand bus in which the stop time length at a first pick-up and drop-off location at which a first user in a wheelchair is to be picked up or dropped off is set longer than the stop time length at a second pick-up and drop-off location at which a second user is to be picked up or dropped off. Thus, it is possible to create an operation plan taking account of the time required for the first user to board or exit the on-demand bus. In consequence, it is possible to prevent the first user from being unsettled when boarding or exiting the on-demand bus and to prevent the operation of the on-demand bus from being delayed from the schedule according to the operation plan. Thus, the technology disclosed herein can improve the convenience of the first user.

An example of the information processing apparatus disclosed herein is a server apparatus run by the provider of on-demand bus service. The controller according to the present disclosure is a processor, such as a CPU (Central Processing Unit) or a DSP (Digital Signal Processor) provided in the server apparatus.

### EMBODIMENT

In the following, a specific embodiment of the technology disclosed herein will be described with reference to the drawings. The features that will be described in connection with the embodiment are not intended to limit the technical scope of the disclosure only to them, unless otherwise stated. In the following description of the embodiment, a case where the information processing apparatus according to the present disclosure is applied to an on-demand bus system will be described.

(Outline of On-Demand Bus System)

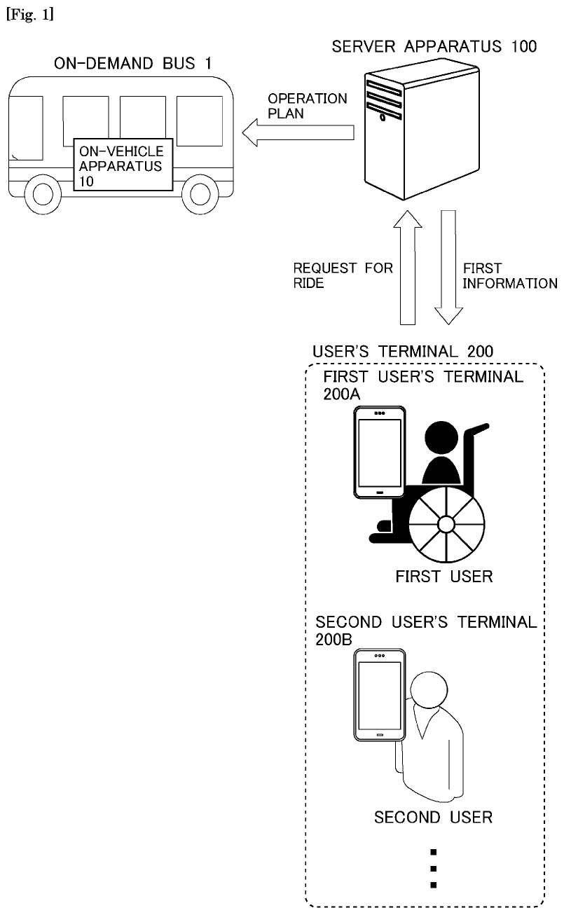

FIG. 1 is a diagram illustrating the general configuration of an on-demand bus system according to the embodiment. The on-demand bus system according to the embodiment includes an on-demand bus 1, a server apparatus 100, and user's terminals 200. While FIG. 1 illustrates only one on-demand bus 1 by way of example, the on-demand bus system may include a plurality of on-demand buses 1.

The user's terminals 200 illustrated in FIG. 1 includes a first user's terminal 200A used by a first user, who is in a wheelchair, and a second user's terminal 200B used by a second user, who is not in a wheelchair. In the following description, the first user's terminal 200A and the second user's terminal 200B are also collectively referred to as the user's terminal(s) 200 where features or functions common to them are described. The term “user” or “users” in the following description can include both the first and second users.

The on-demand bus 1 is a shared vehicle that is operated according to requests for a ride from users. The on-demand bus 1 according to this embodiment is a vehicle that can travel autonomously by autonomous driving. The on-demand bus 1 is provided with an on-vehicle apparatus 10. The on-vehicle apparatus 10 communicates with the server apparatus 100 through wireless communication to receive an operation plan transmitted from the server apparatus 100. The on-vehicle apparatus 10 sends the received operation plan to a control apparatus provided on the on-demand bus 1. The control apparatus is an apparatus that controls the autonomous travel of the on-demand bus 1. Alternatively, the on-demand bus 1 may be a vehicle manually driven by a crew (or driver). Then, the on-vehicle apparatus 10 may be configured to present the operation plan received from the server apparatus 100 to the crew of the on-demand bus 1.

The server apparatus 100 creates an operation plan for the on-demand bus 1 on the basis of requests for a ride from the users. For example, the operation plan contains information on an operation route or a route of travel, pick-up and drop-off locations, expected arrival times at the respective pick-up and drop-off locations, the stop time lengths at the respective pick-up and drop-off locations, and the users to be picked up and dropped off at the pick-up and drop-off locations.

When the server apparatus 100 receives a request for a ride from a second user, it determines the pick-up and drop-off locations for the second user (i.e. the second pick-up and drop-off locations) on the basis of the pick-up and drop-off locations that the second user prefers. For example, the server apparatus 100 selects, as the second pick-up or drop-off location, the stoppable location nearest to the pick-up or drop-off location that the second user prefers from among a plurality of stoppable locations. The stoppable locations mentioned here refer to locations at which the on-demand bus 1 can stop temporarily on the roads on which the on-demand bus 1 can travel.

When the server apparatus 100 receives a request for a ride from a first user, it determines the pick-up and drop-off locations for the first user (i.e. the first pick-up and drop-off locations) on the basis of the starting location and the destination location of the first user. The starting location mentioned here is the location from which the first user will move to the pick-up location at which the first user will board (or be picked up by) the on-demand bus 1. The destination location mentioned here is the location to which the first user will move from the drop-off location at which the first user will exit (or be dropped off by) the on-demand bus 1.

When determining the first pick-up and drop-off locations, the server apparatus 100 determines a plurality of candidate locations for the first pick-up and drop-off locations on the basis of the starting location and the destination location of the first user. The candidate locations include candidate locations for the pick-up location and candidate locations for the drop-off location. For example, the server apparatus 100 chooses stoppable locations that satisfy conditions related to the distance from the starting location, the distance to the destination location, the slope (or grade) of the path from the starting location, and the slope of the path to the destination location from among the stoppable locations and determines the stoppable locations thus chosen as the candidate locations for the first pick-up and drop-off locations.

The server apparatus 100 presents information on the candidate locations for the first pick-up and drop-off locations to the first user through the first user's terminal 200A. This information will be referred to as the “first information” hereinafter. The first information includes information on the path between the starting location and each candidate location for the pick-up location, information on the length of the path between the starting location and each candidate location for the pick-up location, information on the slope of the path between the starting location and each candidate location for the pick-up location, information on whether each candidate location for the pick-up location is roofed, information on the path between each candidate location for the drop-off location and the destination location, information on the length of the path between each candidate location for the drop-off location and the destination location, information on the slope of the path between each candidate location for the drop-off location and the destination location, and information on whether each candidate location for the drop-off location is roofed. The first user selects one candidate location for the pick-up location and one candidate location for the drop-off location that he or she prefers from among the candidate locations, and then the server apparatus 100 determines the candidate location for the pick-up location and the candidate location for the drop-off location selected by the first user as the first pick-up and drop-off locations. In this way, the first user can examine the first information to select candidate locations convenient for move in a wheelchair or candidate locations where he or she can wait for the on-demand bus 1 without rain gear even in rainy weather as the first pick-up and drop-off locations.

The server apparatus 100 according to the embodiment also has the function of setting the stop time length of the on-demand bus 1 at the first pick-up and drop-off locations longer than the stop time length of the on-demand bus 1 at the second pick-up and drop-off locations.

The server apparatus 100 determines the operation route and operation schedule of the on-demand bus 1 on the basis of the pick-up and drop-off locations and the stop time lengths determined as above and the user's preferred pick-up and drop-off time zones. The server apparatus 100 creates an operation plan for the on-demand bus 1 based on the determined operation route and operation schedule. Then, the server apparatus 100 transmits the operation plan thus created to the on-vehicle apparatus 10 of the on-demand bus 1. Moreover, the server apparatus 100 transmits operation information on the operation route and operation schedule of the on-demand bus 1 to the user's terminal 200.

The user's terminal 200 has the function of receiving various information entered by the user regarding the use of the on-demand bus service and the function of presenting various information supplied from the server apparatus 100 to the user.

(Hardware Configuration of On-Demand Bus System)

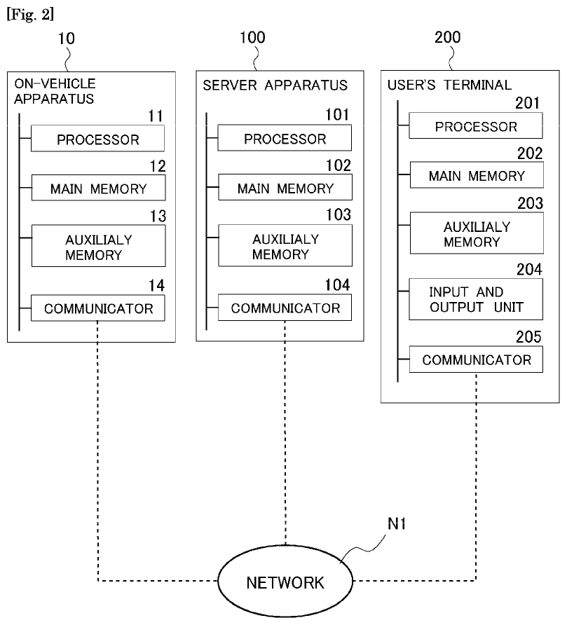

The hardware configuration of the on-demand bus system according to the embodiment will be described with reference to FIG. 2. FIG. 2 illustrates an example of the hardware configurations of the on-vehicle apparatus 10, the server apparatus 100, and the user's terminal 200 included in the on-demand bus system illustrated in FIG. 1. While FIG. 2 illustrates only one on-vehicle apparatus 10 and only one user's terminal 200, the on-demand bus system may include two or more on-vehicle apparatuses 10 and two or more user's terminals 200.

The on-vehicle apparatus 10 is a computer provided on the on-demand bus 1. As illustrated in FIG. 2, the on-vehicle apparatus 10 includes a processor 11, a main memory 12, an auxiliary memory 13, and a communicator 14. The processor 11, the main memory 12, the auxiliary memory 13, and the communicator 14 are interconnected by buses.

The processor 11 may be, for example, a CPU (Central Processing Unit) or a DSP (Digital Signal Processor). The processor 11 executes various processing by loading programs stored in the auxiliary memory 13 into the main memory 12 and executing them.

The main memory 12 is a storage device that provides a memory space and a work space for the processor 11 into which programs stored in the auxiliary memory 13 are loaded and serves as a buffer for computational processing. The main memory 12 includes, for example, a semiconductor memory, such as a RAM (Random Access Memory) and a ROM (Read Only Memory).

The auxiliary memory 13 stores various programs and data used by the processor 11 when executing programs. The auxiliary memory 13 may be, for example, an EPROM (Erasable Programmable ROM) or a hard disk drive (HDD). The auxiliary memory 13 may include a removable medium or a portable recording medium. Examples of the removable medium include a USB (Universal Serial Bus) memory and a disc recording medium, such as a CD (Compact Disc) or a DVD (Digital Versatile Disc). The auxiliary memory 13 stores various programs, various data, and various tables in such a way that they can be written into and read out from it. The programs stored in the auxiliary memory 13 include a program used to relay information related to the operation of the on-demand bus 1 between the control apparatus of the on-demand bus 1 and the server apparatus 100, besides an operating system.

The communicator 14 is a wireless communication circuit. The wireless communication circuit provides the connection to the network N1 through, for example, wireless mobile communications, such as 5G (fifth generation), 6G, 4G, or LTE (Long Term Evolution) mobile communications. The wireless communication circuit may be configured to provide the connection to the network N1 by WiMAX, Wi-Fi (registered trademark) or other wireless communication scheme. The communicator 14 is connected to the network N1 by wireless communication to communicate with the server apparatus 100 through the network N1.

The on-vehicle apparatus 10 having the configuration illustrated in FIG. 2 relays transmission of information between the control apparatus of the on-demand bus 1 and the server apparatus 100. This processing is performed by the processor 11 by loading a program stored in the auxiliary memory 13 into the main memory 12 and executing it. For example, when the communicator 14 receives an operation plan transmitted from the server apparatus 100, the processor 11 transmits the received operation plan to the control apparatus of the on-demand bus 1.

The hardware configuration of the on-vehicle apparatus 10 is not limited to the configuration illustrated in FIG. 2, but some components may be added, removed, or replaced by other components fitly. The processing executed in the on-vehicle apparatus 10 may be executed by either hardware or software.

The server apparatus 100 is a computer that manages the operation of the on-demand bus 1. The server apparatus 100 is run by the provider of the on-demand bus service. As illustrated in FIG. 2, the server apparatus 100 includes a processor 101, a main memory 102, an auxiliary memory 103, and a communicator 104. The processor 101, the main memory 102, the auxiliary memory 103, and the communicator 104 are interconnected by buses.

The processor 101, the main memory 102, and the auxiliary memory 103 of the server apparatus 100 are similar to the processor 11, the main memory 12, and the auxiliary memory 13 of the on-vehicle apparatus 10, and they will not be described further. However, it should be noted that the programs stored in the auxiliary memory 103 of the server apparatus 100 include a program configured to implement the function of creating operation plans for the on-demand bus 1 in the server apparatus 100.

The communicator 104 connects the server apparatus 100 to the network N1. The communicator 104 connects the server apparatus 100 to the user's terminal 200 through the network N1. The communicator 104 includes, for example, a LAN (Local Area Network) interface board or a wireless communication circuit for wireless communication.

The hardware configuration of the server apparatus 100 is not limited to the configuration illustrated in FIG. 2, but some components may be added, removed, or replaced by other components fitly. The processing executed in the server apparatus 100 may be executed by either hardware or software.

The user's terminal 200 is a computer used by a user who wants to ride the on-demand bus 1. The user's terminal 200 may be a smartphone, a tablet terminal, a wearable terminal, or a personal computer. As illustrated in FIG. 2, the user's terminal 200 includes a processor 201, a main memory 202, an auxiliary memory 203, an input and output unit 204, and a communicator 205. The processor 201, the main memory 202, the auxiliary memory 203, the input and output unit 204, and the communicator 205 are interconnected by buses.

The processor 201, the main memory 202, and the auxiliary memory 203 of the user's terminal are similar to the processor 11, the main memory 12, and the auxiliary memory 13 of the on-vehicle apparatus 10, and they will not be described further.

The input and output unit 204 receives input operations conducted by the user and presents information to the user. The input and output unit 204 includes a touch panel display and a control circuit thereof.

The communicator 205 is a wireless communication circuit. The wireless communication circuit provides the connection to the network N1 through, for example, wireless mobile communications, such as 5G (fifth generation), 6G, 4G, or LTE (Long Term Evolution) mobile communications. The wireless communication circuit may be configured to provide the connection to the network N1 by WiMAX, Wi-Fi (registered trademark) or other wireless communication scheme. The communicator 205 is connected to the network N1 by wireless communication to communicate with the server apparatus 100 through the network N1.

The user's terminal 200 having the configuration illustrated in FIG. 2 executes various processing related to the use of the on-demand bus service. Specifically, such processing is executed by the processor 201 by loading a program stored in the auxiliary memory 203 into the main memory 202 and executing it. The user's terminal 200 according to the embodiment interacts with the user. For example, the user's terminal 200 receives the entry of various information related to the use of the on-demand bus service by the user and transmits the entered information to the server apparatus 100. For example, such functions are implemented by a browser running on the user's terminal 200. Alternatively, such functions may be implemented by an application program installed in the user's terminal 200.

The hardware configuration of the user's terminal 200 is not limited to the configuration illustrated in FIG. 2, but some components may be added, removed, or replaced by other components fitly. The processing executed in the user's terminal 200 may be executed by either hardware or software.

(Functional Configuration of Server Apparatus)

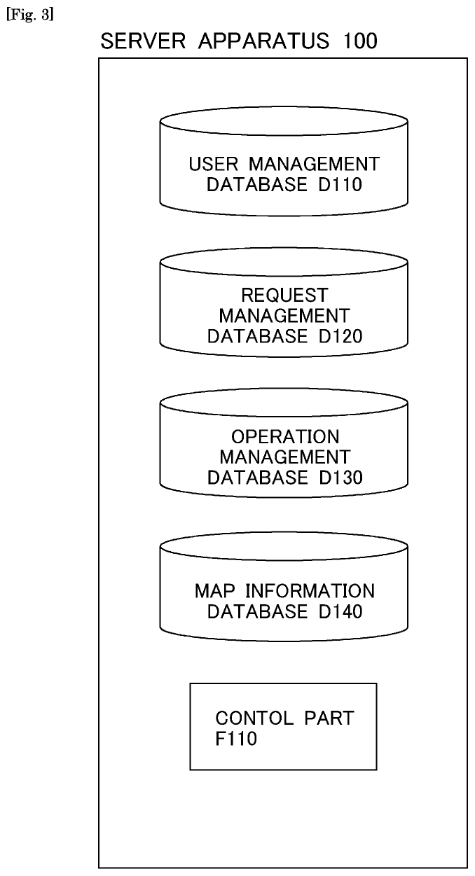

The functional configuration of the server apparatus 100 according to the embodiment will be described with reference to FIG. 3. FIG. 3 is a block diagram illustrating an example of the functional configuration of the server apparatus 100. The server apparatus 100 according to the embodiment is an example of the information processing apparatus disclosed herein.

The server apparatus 100 according to the embodiment is configured to be capable of providing a web server that can interact with the user's terminal 200. When the user logs in to the web server through the browser of the user's terminal 200, the server apparatus 100 can cause the input and output unit 204 of the user's terminal 200 to display web pages of a web site for reservation of the on-demand bus 1. For example, the server apparatus 100 can cause the input and output unit 204 of the first user's terminal 200A to display a web page for entering the starting location and the destination location of the first user, a web page for selecting a candidate location that the first user prefers from among candidate locations for the first pick-up and drop-off locations, and a web page for entering first user's preferred pick-up and drop-off time zones through the browser of the first user's terminal 200A. The server apparatus 100 can also cause the input and output unit 204 of the second user's terminal 200B to display a web page for entering second user's preferred pick-up and drop-off locations and second user's preferred pick-up and drop-off time zones through the browser of the second user's terminal 200B.

The server apparatus 100 may implement interaction with the user's terminal 200 by means other than the web server. For example, the server apparatus 100 may execute processing that implements interaction with the user's terminal 200 through an application program installed in the user's terminal 200 and a specific protocol.

As illustrated in FIG. 3, the server apparatus 100 implementing the above functions has, as functional components, a user management database D110, a request management database D120, an operation management database D130, a map information database D140, and a control part F110.

The user management database D110, the request management database D120, the operation management database D130, and the map information database D140 are constructed by a database management system program (DBMS program) executed by the processor 101. The user management database D110, the request management database D120, the operation management database D130, and the map information database D140 may be constructed as relational databases.

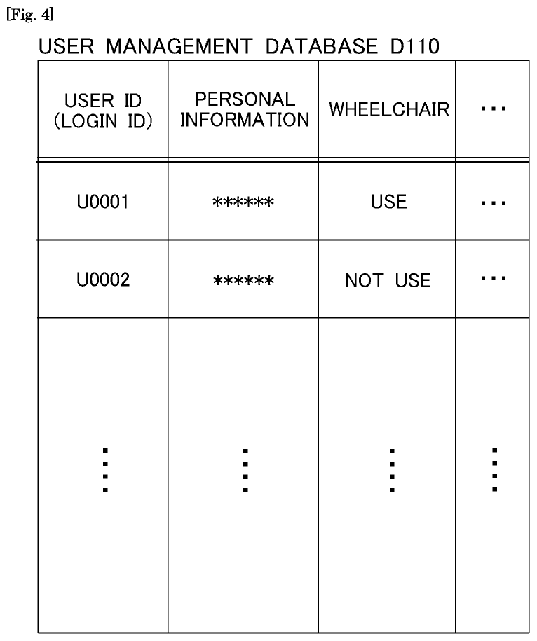

The user management database D110 stores information on users who can use the on-demand service. FIG. 4 illustrates an example of information stored in the user management database D110. The user management database D110 illustrated in FIG. 4 stores a plurality of records respectively corresponding to a plurality of users who can use the on-demand bus service. Each record in the user management database D110 has the fields of user ID (login ID), personal information, and wheelchair. Each record in the user management database D110 is created and registered in the user management database D110 at the time when each user becomes a member of the on-demand bus service.

What is stored in the user ID (login ID) field is information (user ID) that identifies each of the users who are members of the on-demand bus service. The user ID is assigned to each user at the time when the user becomes a member of the on-demand bus service. The user ID is used also as the login ID when each user logs in to the web server (namely, the web site for reservation of the on-demand bus 1).

What is stored in the personal information field is personal information of each user, such as the age, sex, address, and payment method for fare of the on-demand bus 1. The information stored in the personal information field is not limited to the information mentioned above.

What is stored in the wheelchair field is information indicating whether or not each user is a wheelchair user. For example, in the case of the first user, who uses a wheelchair, the information “use” is stored in the wheelchair field of his/her record. In the case of the second user, who does not use a wheelchair, the information “not use” is stored in the wheelchair field of his/her record.

The structure of the records stored in the user management database D110 is not limited to the structure illustrated in FIG. 4, but some fields may be added, removed, or replaced by other fields fitly. For example, besides the aforementioned fields, the record stored in the user management database D110 may include a field for recording the distance through which the first user can move in a wheelchair and a field for storing information indicating whether the first user needs an assistant when boarding or exiting the on-demand bus 1.

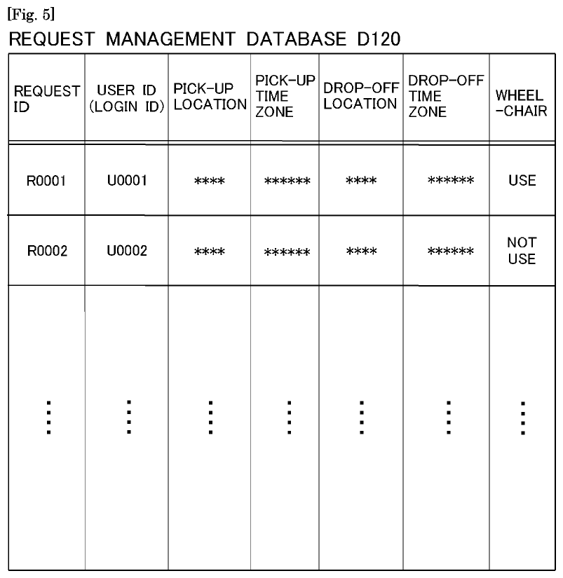

Referring back to FIG. 3, the request management database D120 stores information related to requests for a ride received from the users. FIG. 5 illustrates an example of information stored in the request management database D120. The request management database D120 illustrated in FIG. 5 stores a plurality of records respectively corresponding to a plurality of requests for a ride received from a plurality of users. Each record stored in the request management database D120 has the fields of request ID, user ID (login ID), pick-up location, pick-up time zone, drop-off location, drop-off time zone, and wheelchair. Each record in the request management database D120 is created and registered in the request management database D120 at the time when the server apparatus 100 receives a request for a ride from a user.

What is stored in the request ID field is information (request ID) for identifying each request for ride. The request ID is assigned at the time when the server apparatus 100 receives a request for a ride from a user.

What is stored in the user ID (login ID) field is the user ID of each user who made a request for a ride.

What is stored in the pick-up location field is location information of the pick-up location of each user. The pick-up location mentioned here is not a pick-up location that the user prefers but a pick-up location determined by the server apparatus 100 (specifically, the control part F110 described later). What is stored in the pick-up time zone field is information indicating a pick-up time zone that each user prefers.

What is stored in the drop-off location field is location information of the drop-off location of each user. The drop-off location mentioned here is not a drop-off location that the user prefers but a drop-off location determined by the server apparatus 100 (specifically, the control part F110 described later). What is stored in the drop-off time zone field is information indicating a drop-off time zone that each user prefers.

What is stored in the wheelchair field is information indicating whether each user is a wheelchair user. For example, in the case of a record corresponding to a request for a ride from the first user, who uses a wheelchair, the information “use” is stored in the wheelchair field. In the case of a record corresponding to a request for a ride from the second user, who does not use a wheelchair, the information “not use” is stored in the wheelchair field.

Each record is kept until a trigger for creating an operation plan is generated. The trigger for creating an operation plan may be generated periodically (e.g. at intervals of a few tens of minutes, a few hours, or a day). The trigger for creating an operation plan may be generated at the time a predetermined time earlier than the earliest time zone among the time zones indicated in the pick-up time zone field of the plurality of records stored in the request management database D120.

The structure of the records stored in the request management database D120 is not limited to the structure illustrated in FIG. 5, but some fields may be added, removed, or replaced by other fields fitly.

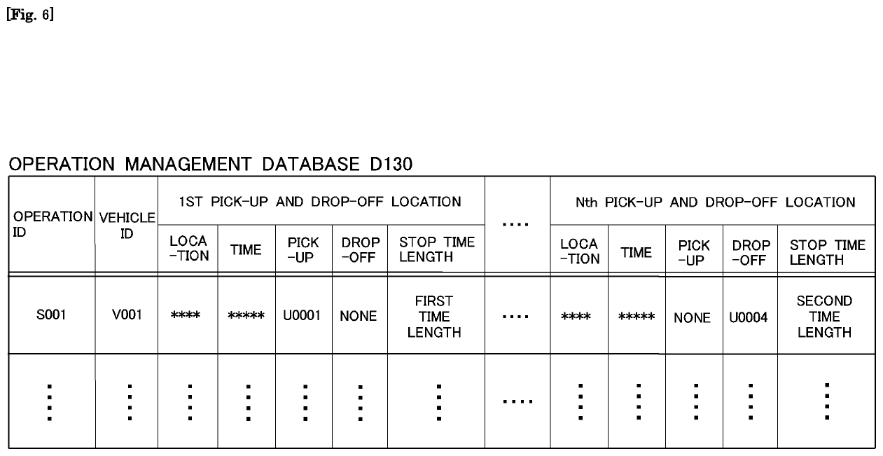

Referring back to FIG. 3, the operation management database D130 stores information related to operation plans of the on-demand bus 1. FIG. 6 illustrates an example of information stored in the operation management database D130. The operation management database D130 illustrated in FIG. 6 stores a plurality of records respectively corresponding to a plurality of operation plans. Each record in the operation management database D130 has the fields of operation ID, vehicle ID, and pick-up and drop-off locations. Each record in the operation management database D130 is created and stored in the operation management data base D130 at the time when an operation plan is created by the server apparatus 100 (specifically, the control part F110 described later).

What is stored in the operation ID field is information (operation ID) identifying each operation plan. The operation ID is assigned when the operation plan is created by the server apparatus 100 (specifically, the control part F110 described later).

What is stored in the vehicle ID field is information (vehicle ID) identifying the on-demand bus 1 used for each operation plan.

What is stored in the pick-up and drop-off location field is information related to a location at which the on-demand bus 1 used for each operation plan is to pick up and/or drop off users. Each record in the operation management database D130 includes a plurality of pick-up and drop-off location fields. For example, a record corresponding to an operation plan having N locations for picking up and/or dropping off users includes N pick-up and drop-off location fields, namely, first to N-th pick-up and drop-off location fields, where N is a natural number larger than 1.

Each pick-up and drop-off location field includes the sub-fields of location, time, pick-up, drop-off, and stop time length. What is stored in the location field is information indicating the location of each pick-up and drop-off location. What is recorded in the time field is the expected arrival time of the on-demand bus 1 at each pick-up and drop-off location. What is recorded in the pick-up field is the user ID of the user to be picked up at each pick-up and drop-off location. In the case of pick-up and drop-off locations where there is no user to be picked up but one or more users to be dropped off, the information “none” is stored in the pick-up field. What is stored in the drop-off field is the user ID of the user to be dropped off at each pick-up and drop-off location. In the case of pick-up and drop-off locations where there is no user to be dropped off but one or more users to be picked up, the information “none” is stored in the drop-off field. What is recorded in the stop time length field is the length of time (stop time length) over which the on demand bus 1 is scheduled to stop at each pick-up and drop-off location. According to the embodiment, a first time length is recorded in the stop time length field for pick-up and drop-off locations at which at least one first user among the first users, who use a wheelchair, and the second users, who do not use a wheelchair, is to be picked up or drop-off. Such pick-up and drop-off locations will be referred to as “first pick-up and drop-off locations” hereinafter. In contrast, a second time length is recorded in the stop time length field for pick-up and drop-off locations at which only a second user or users among the first and second users are to be picked-up and/or dropped off. Such pick-up and drop-off locations will be referred to as “second pick-up and drop-off locations” hereinafter. The first time length is longer than the second time length. The first and second time lengths will be specifically described later.

The structure of the records stored in the operation management database D130 is not limited to the structure illustrated in FIG. 6, but some fields may be added, removed, or replaced by other fields fitly.

Referring back to FIG. 3, the map information database D140 stores map information of the operation area of the on-demand bus 1. The map information stored in the map information database D140 includes information on the road links along which the on-demand bus 1 can travel, information indicating the stoppable locations in each road link along which the on-demand bus 1 can travel, information on whether or not there is a space where a user in a wheelchair can wait at each stoppable location, information on whether or not each stoppable location is roofed, information indicating road links along which wheelchairs can travel, information on the length of each road link along which wheelchairs can travel, and information on the highest slope in each road link along which wheelchairs can travel.

The control part F110 is a functional component used to construct the aforementioned web server. The control part F110 is an example of the controller according to the present disclosure. The control part F110 is implemented by the processor 101 of the server apparatus 100 by executing a program stored in the auxiliary memory 103 into the main memory 102 and executing it. The control part F110 may be implemented by a hardware circuit, such as an ASIC (Application Specific Integrated Circuit) or an FPGA (Field Programmable Gate Array). In this case, the hardware circuit corresponds to the controller according to the present disclosure.

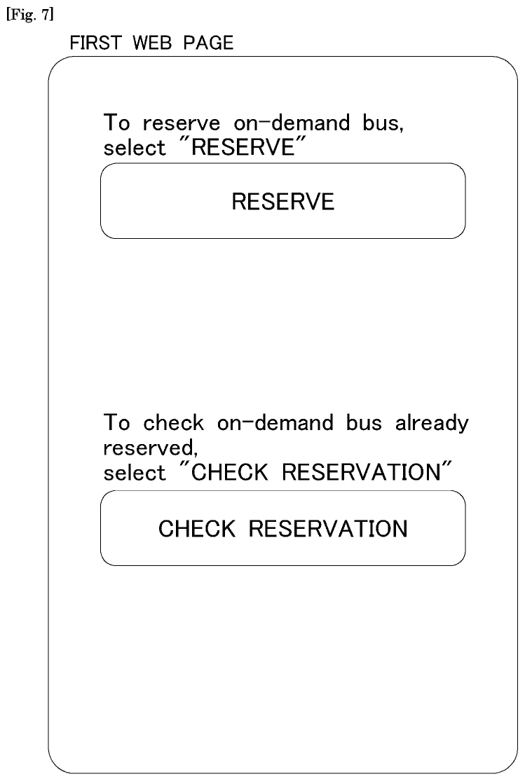

When the user logs in to the web server through the browser of the user's terminal 200, the control part F110 causes the browser of the user's terminal 200 to display a web page of a site for reservation. FIG. 7 illustrates an example of the web page that is displayed by the browser of the user's terminal 200 when the user logs in to the web server. This web page will also be referred to as the “first web page” hereinafter. The exemplary first web page illustrated in FIG. 7 contains the “Reserve” button, the “Check Reservation” button, and their explanations.

When the user selects the “Check Reservation” button on the first web page illustrated in FIG. 7 through the user's terminal 200, the control part F110 causes the browser of the user's terminal 200 to display a list of the requests for a ride that the user has reserved. Thus, the user can check the reserved requests for a ride.

When the user selects the “Reserve” button on the first web page illustrated in FIG. 7 through the user's terminal 200, the control part F110 executes the processing of receiving a request for a ride. In the processing of receiving a request for a ride, the control part F110 firstly determines whether the user is a first user (i.e. a user who uses a wheelchair) or a second user (i.e. a user who does not use a wheelchair). Specifically, the control part F110 accesses the user management database D110 using the login ID (user ID) of the user as an argument to find the record corresponding to the user. Then, the control part F110 determines whether the user is a first user or a second user based on the information stored in the wheelchair field of the record thus found. If the information “use” is stored in the wheelchair field, the control part F110 determines that the user is a first user. If the information “not use” is stored in the wheelchair field, the control part F110 determines that the user is a second user.

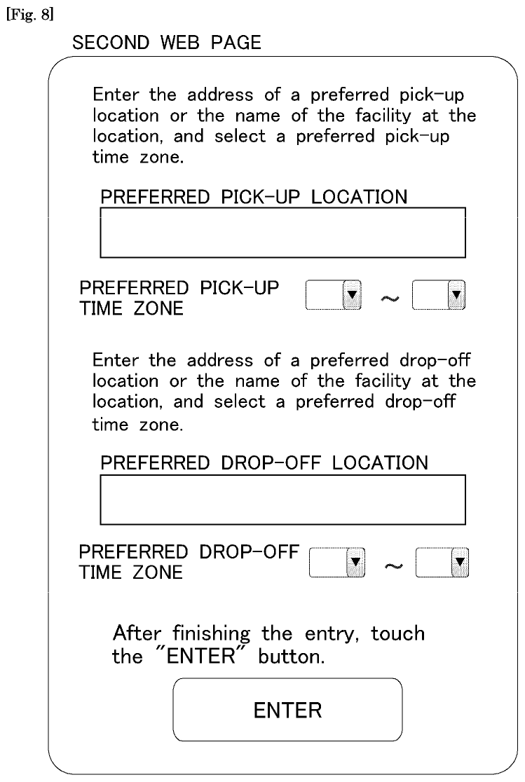

If it is determined that the user is a second user, the control part F110 causes the browser of the user's terminal 200 (which is the second user's terminal 200B) of the second user to display a web page for entering second user's preferred pick-up and drop-off locations and pick-up and drop-off time zones. This web page will also be referred to as the “second web page” hereinafter. FIG. 8 illustrates an example of the second web page displayed by the browser of the second user's terminal 200B. The second web page illustrated in FIG. 8 contains a field for entering a pick-up location that the second user prefers (preferred pick-up location), a pull-down menu for selecting a pick-up time zone that the second user prefers (preferred pick-up time zone), a message prompting the user to enter a preferred pick-up location and to select a preferred pick-up time zone, a field for entering a drop-off location that the second user prefers (preferred drop-off location), a pull-down menu for selecting a drop-off time zone that the second user prefers (preferred drop-off time zone), a message prompting the user to enter a preferred drop-off location and to select a preferred drop-off time zone, the “Enter” button, and an explanation of the “Enter” button.

If the second user enters a preferred pick-up location, selects a preferred pick-up time zone, enters a preferred drop-off location, selects a preferred drop-off time zone, and selects the “Enter” button on the second web page illustrated in FIG. 8, the control part F110 determines pick-up and drop-off locations for the second user (second pick-up and drop-off locations). Specifically, the control part F110 according to the embodiment accesses the map information database D140 to select the stoppable locations closest to the second user's preferred pick-up and drop-off locations, namely, the stoppable location closest to the second user's preferred pick-up location and the stoppable location closest to the second user's preferred drop-off location, among the stoppable locations in the operation area of the on-demand bus 1. The control part F110 determines the stoppable locations thus selected as the second pick-up and drop-off locations. As described previously, the stoppable locations are locations on the roads on which the on-demand bus 1 can travel and at which the on-demand bus 1 can stop temporarily.

In cases where preferred pick-up locations (or drop-off locations) of a plurality of second users are close to each other and they want to move to the same direction, the control part F110 may determine the same stoppable location as the pick-up location (or drop-off location) for the plurality of second users.

After determining the second pick-up and drop-off locations, the control part F110 creates a new record as illustrated in FIG. 5 and stores it in the request management database D120. The request ID field of this new record records a request ID that is newly assigned by the control part F110. The user ID field of this new record records the user ID of the second user. The pick-up location field of this new record records the pick-up location determined by the control part F110. The pick-up time zone field of this new record records the second user's preferred pick-up time zone. The drop-off location field of this new record records the drop-off location determined by the control part F110. The drop-off time zone field of this new record records the second user's preferred drop-off time zone. The wheelchair field of this new record records the information “not use”.

After the record corresponding to the request for a ride by the second user is stored in the request management database D120, the control part F110 displays information indicating the completion of the acceptance of the request for a ride through the browser of the second use's terminal 200B.

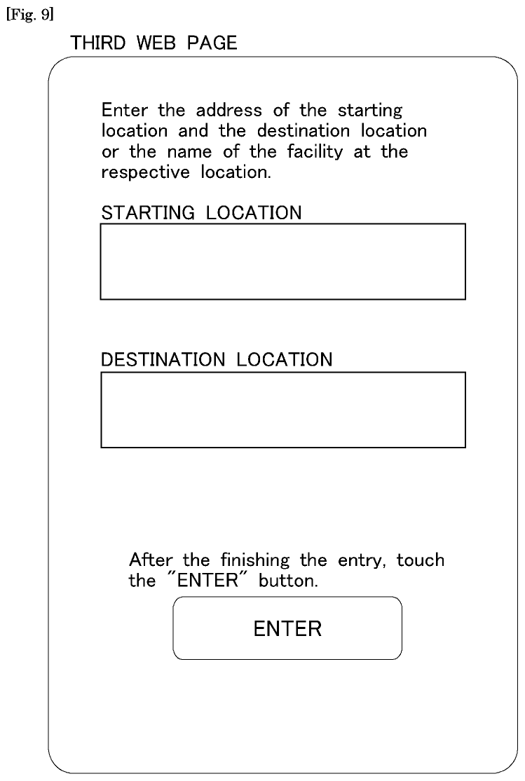

If it is determined that the user is a first user, the control part F110 causes the browser of the user's terminal 200 (which is the first user's terminal 200A) of the first user to display a web page for entering the starting location and the destination location of the first user. This web page will also be referred to as the “third web page” hereinafter. FIG. 9 illustrates an example of the third web page displayed by the browser of the first user's terminal 200A. The third web page illustrated in FIG. 9 contains a field for entering the starting location, a field for entering the destination location, a message prompting the user to enter the starting location and the destination location, and the “Enter” button.

If the first user enters the starting location and the destination location and selects the “Enter” button on the third web page illustrated in FIG. 9 through the browser of the first user's terminal 200A, the control part F110 determines candidate locations for the pick-up and drop-off locations for the first user (i.e. the first pick-up and drop-off locations). Specifically, the control part F110 firstly chooses stoppable locations that satisfy the following conditions (1) to (4) based on the map information stored in the map information database D140 and the starting location of the first user.
Condition (1): stoppable locations located within a predetermined distance (e.g. several to several tens meters) from the starting location
Condition (2): stoppable locations for which the slope of the path from the starting location to the stoppable locations does not exceed a predetermined threshold value (e.g. 3 degree to 5 degree)
Condition (3): stoppable locations having a space where a user in a wheelchair can wait
Condition (4): stoppable locations having a roof

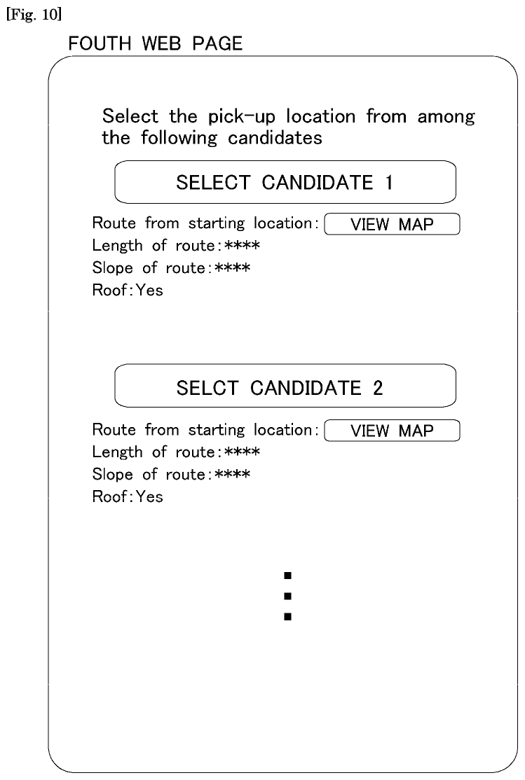

The control part F110 determines the stoppable locations chosen as above as candidate locations for the pick-up location for the first user. Then, the control part F110 causes the browser of the first user's terminal 200A to display a web page for selecting the pick-up location for the first user from among the candidate locations for the pick-up location. This web page will also be referred to as the “fourth web page” hereinafter. FIG. 10 illustrates an example of the fourth web page displayed by the browser of the first user's terminal 200A. The fourth web page illustrated in FIG. 10 contains a message prompting the user to select the pick-up location from among the plurality of candidate locations, the “Select Candidate Location” buttons for the respective candidate locations, and descriptions of the respective candidate locations. The description of each candidate location includes information on the route from the starting location, the length of the route, the slope of the route, and whether the candidate location has a roof. The display area that describes the route from the starting location contains the “View Map” button. When the “View Map” button is selected, the control part F110 causes the browser of the first user's terminal 200A to display map information illustrating the route from the starting location to the candidate location.

If the first user selects the “Select Candidate Location” button corresponding to one of the candidate locations on the fourth web page illustrated in FIG. 10 through the browser of the first user's terminal 200A, the control part F110 determines the candidate location thus selected by the first user as the pick-up location for the first user.

After determining the pick-up location for the first user, the control part F110 chooses stoppable locations that satisfy the following conditions (5) to (7) based on the map information stored in the map information database D140 and the destination location of the first user.
Condition (5): stoppable locations located within a predetermined distance (e.g. several to several tens meters) from the destination location
Condition (6): stoppable locations for which the slope of the path from the stoppable locations to the destination location does not exceed a predetermined threshold value (e.g. 3 degree to 5 degree)
Condition (7): stoppable locations having a roof

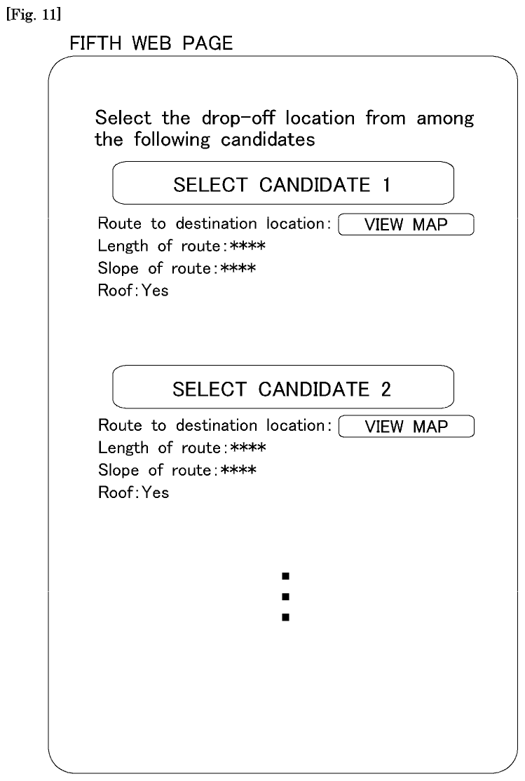

The control part F110 determines the stoppable locations chosen as above as candidate locations for the drop-off location for the first user. Then, the control part F110 causes the browser of the first user's terminal 200A to display a web page for selecting the drop-off location for the first user from among the candidate locations for the drop-off location. This web page will also be referred to as the “fifth web page” hereinafter. FIG. 11 illustrates an example of the fifth web page displayed by the browser of the first user's terminal 200A. The fifth web page illustrated in FIG. 11 contains a message prompting the user to select the drop-off location from among the plurality of candidate locations, the “Select Candidate Location” buttons for the respective candidate locations, and descriptions of the respective candidate locations. The description of each candidate location includes information on the route to the destination location, the length of the route, the slope of the route, and whether the candidate location has a roof. The display area that describes the route to the destination location contains the “View Map” button. When the “View Map” button is selected, the control part F110 causes the browser of the first user's terminal 200A to display map information illustrating the route from the candidate location to the destination location.

The information contained in the fourth web page and the information contained in the fifth web page are examples of the first information according to the present disclosure.

If the first user selects the “Select Candidate Location” button corresponding to one of the candidate locations on the fifth web page illustrated in FIG. 11 through the browser of the first user's terminal 200A, the control part F110 determines the candidate location thus selected by the first user as the drop-off location for the first user.

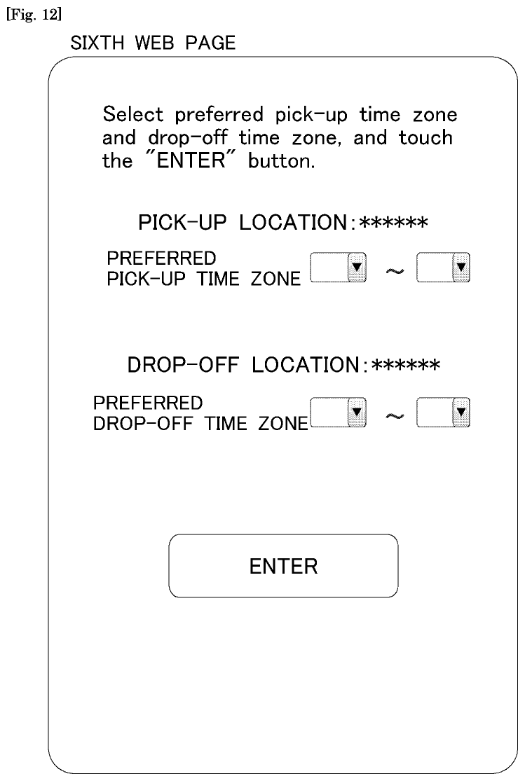

After determining the drop-off location for the first user, the control part F110 causes the browser of the first user's terminal 200A to display a web page for entering pick-up and drop-off time zones that the first user prefers. This web page will also be referred to as the “sixth web page” hereinafter. FIG. 12 illustrates an example of the sixth web page displayed by the browser of the first user's terminal 200A. The sixth web page illustrated in FIG. 12 contains information indicating the pick-up location for the first user, a pull-down menu for selecting a pick-up time zone that the first user prefers (preferred pick-up time zone), information indicating the drop-off location for the first user, a pull-down menu for selecting a drop-off time zone that the first user prefers (preferred drop-off time zone), a message prompting the first user to select a preferred pick-up time zone and a preferred drop-off time zone, and the “enter” button.

When the first user finishes selecting a preferred pick-up time zone and a preferred drop-off time zone and selects the “Enter” button on the sixth web page illustrated in FIG. 12 through the first user's terminal 200A, the control part F110 creates a new record as illustrated in FIG. 5 and stores it in the request management database D120. The request ID field of this new record records a request ID that is newly assigned by the control part F110. The user ID field of this new record records the user ID of the first user. The pick-up location field of this new record records the pick-up location selected by the first user. The pick-up time zone field of this new record records the first user's preferred pick-up time zone. In the drop-off location field of this new record records the drop-off location selected by the first user. In the drop-off time zone field of this new record records the first user's preferred drop-off time zone. The wheelchair field of this new record records the information “use”.

After the record corresponding to the request for a ride by the first user is stored in the request management database D120, the control part F110 displays information indicating the completion of the acceptance of the request for a ride through the browser of the first use's terminal 200A.

At the time when the aforementioned trigger for creating an operation plan is generated, the control part F110 creates an operation plan for the on-demand bus 1 based on the information stored in the request management database D120.

In the process of creating the operation plan, the control part F110 firstly groups a plurality of users who can be transported by the same on-demand bus 1 based on the information stored in the request management database D120. For example, the control part F110 groups users who want to move in the same direction in the same time zone.

The control part F110 determines an operation route around the pick-up and drop-off locations for the users belonging to each group. For example, the control part F110 determines the operation route by joining road links along which the on-demand bus 1 can travel based on the information stored in the map information database D140.

The control part F110 determines an operation schedule of the on-demand bus 1 for each group. The operation schedule includes the stop time lengths over which the on-demand bus 1 is scheduled to stop at the respective pick-up and drop-off locations for each group and scheduled times at which the on-demand bus 1 arrives at the respective pick-up and drop-off locations for each group.

The control part F110 according to the embodiment sets the stop time length at the first pick-up and drop-off locations at which at least one first user among the first and second users is to be picked up or dropped off to a first time length. The control part F110 according to the embodiment sets the stop time length at the second pick-up and drop-off locations at which only a second user or users among the first and second users are to be picked up or dropped off to a second time length. The first time length is set longer than the second time length. For example, the first time length is set equal to the second time length plus a specific time length Δt. For example, the specific time length Δt is a time length equal to the difference between the time it takes for the second user to board or exit the on-demand bus 1 and the time it takes for the first user to board or exit the on-demand bus 1. The specific time length Δt is determined statistically based on the result of an experiment or simulation.

The larger the number of first users who are to be picked up or dropped off at a pick-up and drop off location is, the longer the specific time length Δt at this location may be made. The second time length may be a constant value. Alternatively, the larger the number of second users who are to be picked up or dropped off at a pick-up and drop-off location is, the longer the second time length at this location may be made.

After determining the stop time lengths at the respective pick-up and drop-off locations for each group, the control part F110 determines expected arrival times of the on-demand bus 1 at the respective pick-up and drop-off locations for the users belonging to each group. For example, the control part F110 determines the expected arrival times at the respective pick-up and drop-off locations based on the distances between the pick-up and drop-off locations along the operation route and the stop time lengths at the respective pick-up and drop-off locations.

After determining the operation route and the operation schedule, the control part F110 creates a new record as illustrated in FIG. 6 and stores it in the operation management database D130. The operation ID field of this new record records an operation ID newly assigned by the control part F110. The vehicle ID field of this new record records the vehicle ID of the on-demand bus 1 assigned to each group by the control part F110. Each of the pick-up and drop-off location fields of this new record records the location information of the pick-up and drop-off location, the expected arrival time at the pick-up and drop-off location, the user ID or IDs of the user or users who are to be picked up at the pick-up and drop-off location (or the information “none”, if there are no such users), the user ID or IDs of the user or users who are to be dropped off at the pick-up and drop-off location (or the information “none”, if there are no such users), and the stop time length at the pick-up and drop-off location.

The control part F110 creates an operation plan including the operation route and the operation schedule of each group. The control part F110 sends the operation plan thus created to the on-vehicle apparatus 10 of the on-demand bus 1 assigned to each group through the communicator 104. Consequently, the on-demand bus 1 can travel autonomously by autonomous driving according to the operation plan.

The control part F110 transmits reservation information to the user's terminals 200 of the users belonging to each group through the communicator 104. For example, the reservation information includes identification information of the on-demand bus 1 (e.g. characters displayed on the body of the on-demand bus 1 or the characters read on the number plate of the on-demand bus) by which each user is to be picked up, information on the pick-up location, information on the pick-up time (namely, the expected arrival time of the on-demand bus 1 at the pick-up location), information on the drop-off location, and information on the drop-off time (namely, the expected arrival time of the on-demand bus 1 at the drop-off location).

The process of creating an operation plan is not limited to the above process. Operation plans may be created by any process so long as the stop time length at the first pick-up and drop-off locations is set longer than the stop time length at the second pick-up and drop-off locations. For example, the operation route may be determined by a known process.

(Process Executed in Server Apparatus)

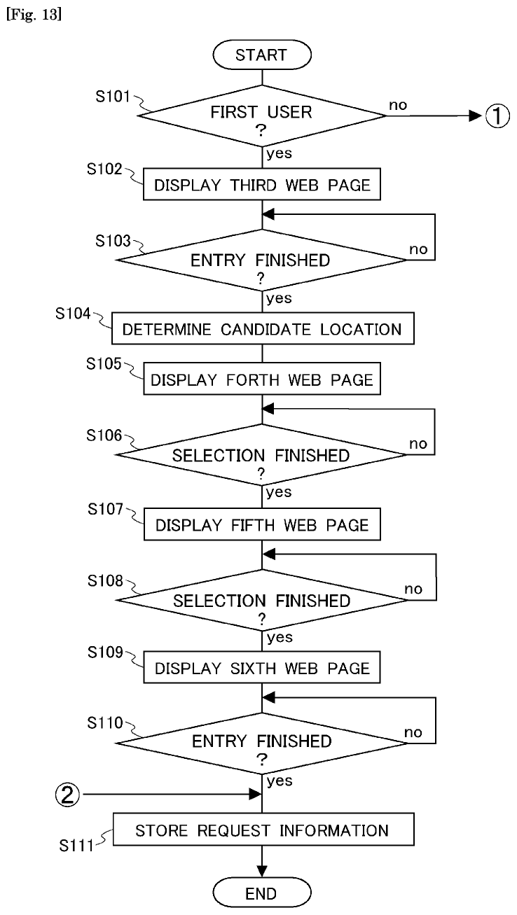

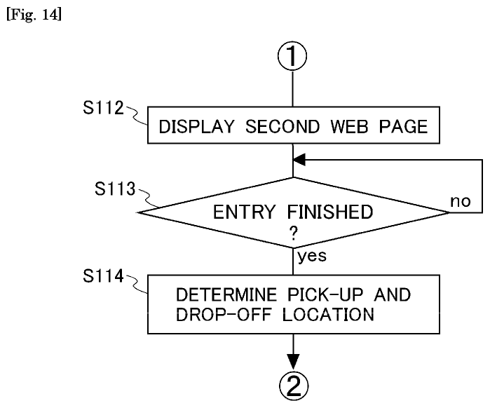

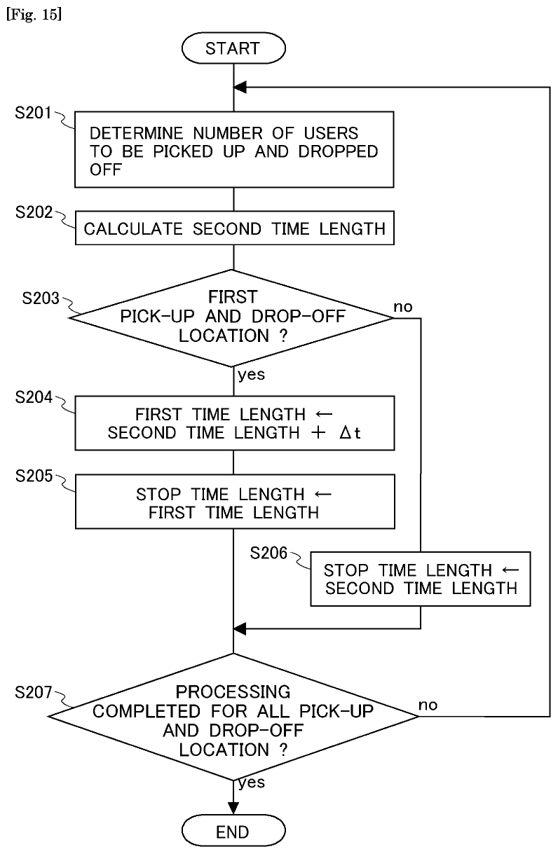

A process executed in the server apparatus 100 will be described with reference to FIGS. 13 to 15. FIGS. 13 and 14 are flow charts of a processing routine executed in the server apparatus 100. FIG. 15 is a flow chart of a processing routine executed in the server apparatus 100 to determine the stop time lengths at the pick-up and drop-off locations.

Firstly, the processing of determining the pick-up and drop-off locations of a user will be described with reference FIGS. 13 and 14. The processing routine according to the flow charts of FIGS. 13 and 14 is triggered by the selection of the “Reserve” button on the aforementioned first web page illustrated in FIG. 7 and executed in the server apparatus 100. While the processing routine according to the flow charts of FIGS. 13 and 14 is executed by the processor 101 of the server apparatus 100, functional components of the server apparatus 100 will be mentioned in the following description as components that execute the processing in the routine.

In the process according to the flow chart of FIG. 13, when the “Reserve” button is selected on the first web page, the control part F110 of the server apparatus 100 determines whether the user who logs in the web server (namely, the web site for reservation) is a first user (step S101). Specifically, the control part F110 accesses the user management database D110 using the login ID (or user ID) of the user as an argument to find the record corresponding to this user. If the information “use” is stored in the wheelchair field of the record thus found, the control part F110 determines that this user is a first user (affirmative answer in step S101). If the information “not use” is stored in the wheelchair field of this record, the control part F110 determines that this user is a second user (negative answer in step S101). If step S101 is answered in the affirmative, the control part F1110 executes the processing of step S102 next.

In step 102, the control part F110 causes the browser of the first user's terminal 200A to display the third web page (illustrated in FIG. 9) for entering the starting location and the destination location of the first user. After completing the processing of step S102, the control part F110 executes the processing of step S103.

In step S103, the control part F110 determines whether the first user has finished entering the starting location and the destination location. If the first user has not finished entering the starting location and the destination location (negative answer in step S103), the control part F110 waits until the first user finishes entering the starting location and the destination location. If the first user has finished entering the starting location and the destination location (affirmative answer in step S103), the control part F110 executes the processing of step S104 next.

In step S104, the control part F110 determines candidate locations for the pick-up and drop-off locations for the first user. Specifically, the control part F110 chooses the stoppable locations that satisfy the conditions (1) to (4) mentioned above based on the map information stored in the map information database D140 and the starting location entered in step S103. The control part F110 determines the stoppable locations chosen as above as the candidate locations for the pick-up location for the first user. Furthermore, the control part F110 chooses the stoppable locations that satisfy the conditions (5) to (7) mentioned above based on the map information stored in the map information database D140 and the destination location entered in step S103. The control part F110 determines the stoppable locations chosen as above as the candidate locations for the drop-off location for the first user. After completing the processing of step S104, the control part F110 executes the processing of step S105 next.

In step S105, the control part F110 causes the browser of the first user's terminal 200A to display the fourth web page (illustrated in FIG. 10) for selecting the pick-up location from among the candidate locations for the pick-up location determined in step S104. After completing the processing of step S105, the control part F110 executes the processing of step S106 next.

In step S106, the control part F110 determines whether the first user has finished selecting the pick-up location. If the first user has not finished selecting the pick-up location (negative answer in step S106), the control part F110 waits until the first user finishes selecting the pick-up location. If the first user has finished selecting the pick-up location (affirmative answer in step S106), the control part F110 executes the processing of step S107 next.

In step S107, the control part F110 causes the browser of the first user's terminal 200A to display the fifth web page (illustrated in FIG. 11) for selecting the drop-off location from among the candidate locations for the drop-off location determined in step S104. After completing the processing of step S105, the control part F110 executes the processing of step S108 next.

In step S108, the control part F110 determines whether the first user has finished selecting the drop-off location. If the first user has not finished selecting the drop-off location (negative answer in step S108), the control part F110 waits until the first user finishes selecting the drop-off location. If the first user has finished selecting the drop-off location (affirmative answer in step S108), the control part F110 executes the processing of step S109 next.

In step S109, the control part F110 causes the browser of the first user's terminal 200A to display the sixth web page (illustrated in FIG. 12) for entering first user's preferred pick-up and drop-off time zones. After completing the processing of step S109, the control part F110 executes the processing of step S110 next.

In step S110, the control part F110 determines whether the first user has finished entering pick-up and drop-off time zones (i.e. a preferred pick-up time zone and a preferred drop-off time zone). If the first user has not finished entering pick-up and drop-off time zones (i.e. a preferred pick-up time zone and a preferred drop-off time zone), in other words, if step S110 is answered in the negative, the control part F110 waits until the first user finishes entering pick-up and drop-off time zones (i.e. a preferred pick-up time zone and a preferred drop-off time zone). If the first user has finished entering pick-up and drop-off time zones (i.e. a preferred pick-up time zone and a preferred drop-off time zone), in other words, if step S110 is answered in the affirmative, the control part F110 executes the processing of step S111.

In step S111, the control part F110 stores information related to the request for a ride from the first user in the request management database D120. Specifically, the control part creates a new record as illustrated in FIG. 5 and stores it in the request management database D120. The request ID field of this new record records a request ID that is newly assigned by the control part F110. The user ID field of this new record records the user ID of the first user. The pick-up location field of this new record records the pick-up location selected by the first user in step S106. The pick-up time zone field of this new record records the preferred pick-up time zone entered by the first user in step S110. The drop-off location field of this new record records the drop-off location selected by the first user in step S108. The drop-off time zone field of this new record records the preferred drop-off time zone entered by the first user in step S110. The wheelchair field of this new record records the information “use”.

After completing the processing of step S111, the control part F110 terminates the execution of this processing routine. Then, the control part F110 may cause the browser of the first user's terminal 200A to display information indicating the completion of the acceptance of the request for a ride.

If it is determined in step S101 in FIG. 13 that the user who logs in the web server is a second user (negative answer in step S101), the control part F110 executes the processing routine according to the flow chart of FIG. 14.

In the routine according to the flow chart of FIG. 14, the control part F110 causes the browser of the second user's terminal 200B to display the second web page for entering pick-up and drop-off locations and pick-up and drop-off time zones that the second user prefers (step S112). After completing the processing of step S112, the control part F110 executes the processing of step S113 next.

In step S113, the control part F110 determines whether the second user has finished entering a preferred pick-up location, a preferred pick-up time zone, a preferred drop-off location, and a preferred drop-off time zone. If the second user has not finished entering the information (negative answer in step S113), the control part F110 waits until the second user finishes entering the information. If the second user has finished entering the information (affirmative answer in step S113), the control part F110 executes the processing of step S114 next.

In step S114, the control part F110 determines the pick-up and drop-off locations for the second user (second pick-up and drop-off locations). Specifically, the control part F110 accesses the map information database D140 and determines the stoppable location closest to the preferred pick-up location entered in step S113 among the stoppable locations located in the operation area of the on-demand bus 1 as the pick-up location for the second user. The control part F110 also determines the stoppable location closest to the preferred drop-off location entered in step S113 among the stoppable locations located in the operation area of the on-demand bus 1 as the drop-off location for the second user.

After completing the processing of step S114, the control part F110 executes the processing of step S111 in FIG. 13 next. In this case, the user ID field of the new record stored in the request management database D120 records the user ID of this second user. The pick-up location field of the new record records the pick-up location determined in step S114. The pick-up time zone field of the new record records the preferred pick-up time zone entered in step S113. The drop-off location field of the new record records the drop-off location determined in step S114. The drop-off time zone field of the new record records the preferred drop-off time zone entered in step S113. The wheelchair field of the new record records the information “not use”.

Next, a process of determining stop time lengths at the pick-up and drop-off locations will be described with reference to FIG. 15. The processing routine according to the flow chart of FIG. 15 is triggered by the determination of the operation route of the on-demand bus 1 and executed in the server apparatus 100. While the processing routine according to the flow chart of FIG. 15 is executed by the processor 101 of the server apparatus 100, functional components of the server apparatus 100 will be mentioned in the following description as components that execute the processing in the routine.

In the processing routine according to the flow chart of FIG. 15, the control part F110 determines the number of users who are to be picked up or dropped off at the pick-up and drop-off location to which this processing routine is applied (which will be referred to as the target pick-up and drop off location) among the pick-up and drop-off locations included in the operation route (step S201). The number of users who are to be picked up or dropped off at the pick-up and drop-off location will also be referred to as “the number of picked-up/dropped-off users” hereinafter. For example, the control part F110 accesses the request management database D120 to find the records of the users who belong to the group for which the operation route has been determined. Then, the control part F110 determines the number of users whose record found as above records the target pick-up and drop-off location in its pick-up location field or drop-off location field. After completing the processing of step S201, the control part F110 executes the processing of step S202 next.

In step S202, the control part F110 calculates the second time length. The control part F110 calculates the second time length in such a way that the larger the number of picked-up/dropped-off users at the target pick-up and drop-off location is, the longer the second time length is. After completing the processing of step S202, the control part F110 executes the processing of step S203 next.

In step S203, the control part F110 determines whether the target pick-up and drop-off location is the first pick-up and drop-off location. In other words, the control part F110 determines whether a first user is included in the users who are to be picked up or dropped off at the target pick-up and drop-off location. This determination is made based on the ride request information (i.e. information stored in the request management database D120) of the users who are to be picked up or dropped off at the target pick-up and drop-off location. For example, if the users who are to be picked up or dropped off at the target pick-up and drop-off location include a user whose record in the request management database D120 records the information “use” in its wheelchair field, the control part F110 determines that the target pick-up and drop-off location is the first pick-up and drop-off location (affirmative answer in step S203). If the users who are to be picked up or dropped off at the target pick-up and drop-off location do not include a user whose record in the request management database D120 records the information “use” in its wheelchair field, the control part F110 determines that the target pick-up and drop-off location is not the first pick-up and drop-off location (negative answer in step S203).

If step S203 is answered in the affirmative, the control part F110 executes the processing of steps S204 and S205 next. In step S204, the control part F110 calculates the first time length by adding a certain time length Δt to the second time length calculated in step S202. In step S205, the control part F110 sets the stop time length at the target pick-up and drop-off location to the first time length calculated in step S204.

If step S203 is answered in the negative, the control part F110 executes the processing of step S206. In step S206, the control part F110 sets the stop time length at the target pick-up and drop-off location to the second time length calculated in step S202.

After completing the processing of step S205 or S206, the control part F110 executes the processing of step S207 next. In step S207, the control part F110 determines whether the processing of determining the stop time length has been completed for all the pick-up and drop-off locations in the operation route. If step S207 is answered in the negative, the control part F110 executes the processing of step S201 onward again. If step S207 is answered in the affirmative, the control part F110 terminates the execution of this processing routine.

### Operation and Advantageous Effects of Embodiment

The system according to the embodiment allows the first user, who is in a wheelchair, to board the on-demand bus 1 at a location that is near his or her starting location and to which he or she can move from the starting location without going through a steep slope and to exit the on-demand bus 1 at a location that is near his or her destination location and from which he or she can move to the destination location without going through a steep slope. Furthermore, the system can set the pick-up location for the first user to a location having a roof where there is a space allowing the first user to wait in a wheelchair.

The system according to the embodiment creates operation plans in such a way as to set the stop time length at the first pick-up and drop-off locations longer than the stop time length at the second pick-up and drop-off locations. This can prevent the first user from being unsettled when boarding or exiting the on-demand bus 1 and the operation of the on-demand bus 1 from being delayed from the schedule according to the operation plan. In particular, even when there is no crew who helps the first user board or exit the on-demand bus 1, as is the case when the on-demand bus 1 is an autonomous vehicle that travels by autonomous driving, the system can set the stop time length taking into account the time it takes for the first user to board or exit the on-demand bus 1 without help by a crew.

As above, the system according to the embodiment can improve the convenience of the first user when using the on-demand bus 1.

### <Modification>

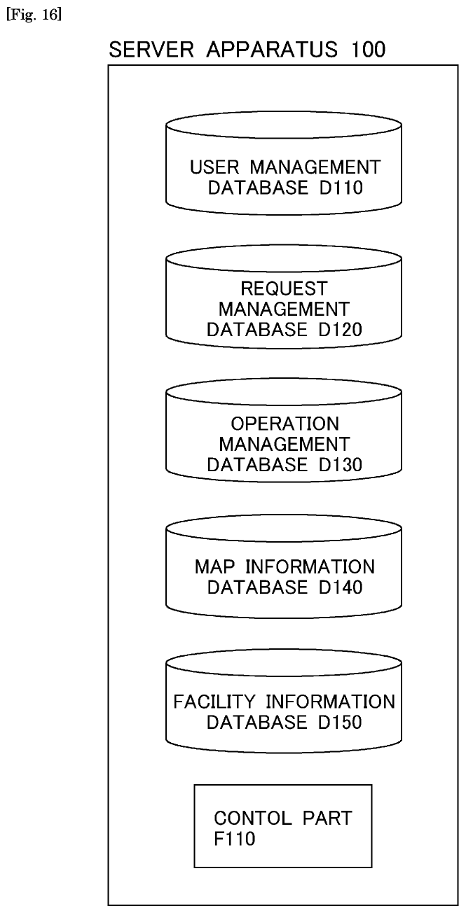

A modification of the above-described embodiment will be described with reference to FIGS. 16 to 21. The features and processing of this modification that are the same as those of the above-described embodiment will not be described further.

FIG. 16 is a block diagram illustrating the functional configuration of the server apparatus 100 according to the modification. As illustrated in FIG. 16, the server apparatus 100 according to the modification has, as functional components, a facility information database D150 in addition to the user management database D110, the request management database D120, the operation management database D130, the map information database D140, and the control part F110.

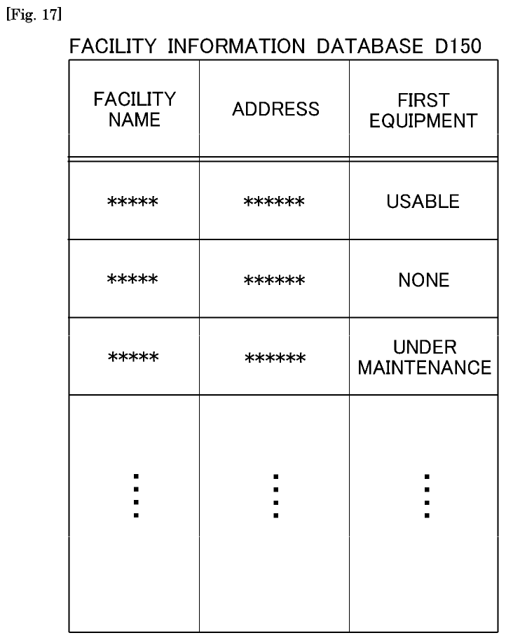

The facility information database D150 is a relational database constructed by a DBMS program executed by the processor 101. The facility information database D150 stores information on facilities located in the operation area of the on-demand bus 1. FIG. 17 illustrates an example of the information stored in the facility information database D150. The facility information database D150 illustrated in FIG. 17 stores a plurality of records corresponding to the respective facilities located in the operation area. Each record stored in the facility information database D150 includes the fields of facility name, address, and first equipment.

What is recorded in the facility name field is the name of each facility. What is recorded in the address field is the address of the facility. What is stored in the first equipment field is information related to the first equipment. Examples of the first equipment include an elevator for people in a wheelchair, a toilet for people in a wheelchair, and a slope for wheelchairs. If a facility does not have such first equipment, the information “none” is recorded in the first equipment field of the corresponding record. If a facility has first equipment, and the first equipment is in a usable state, the information “usable” is recorded in the first equipment field of the corresponding record. If a facility has first equipment, but the first equipment is not usable due to a maintenance work, the information “under maintenance” is recorded in the first equipment field of the corresponding record. If a facility has first equipment, but the first equipment is out of order, the information “out of order” may be recorded in the first equipment field of the corresponding record, though not illustrated in FIG. 17.

The structure of the records stored in the facility information database D150 is not limited to the structure illustrated in FIG. 17, but some fields may be added, removed, or replaced by other fields fitly.

When the control part F110 according to the modification receives information about the starting location and the destination location of the first user, the control part F110 determines whether the first equipment is unusable in the facility at the destination location. Specifically, when the first user enters the starting location and the destination location and selects the “Enter” button on the third web page illustrated in FIG. 9 through the browser of the first user's terminal 200A, the control part F110 accesses the facility information database using the name of the facility at the destination location or the address of the destination location as an argument. The control part F110 finds a record in which information that matches the name of the facility at the destination location of the first user or the address of the destination location of the first user is recorded in its facility name field or address field from among the records stored in the facility information database D150. The control part F110 determines whether the first equipment is usable based on the information recorded in the first equipment field of the record found as above. If the information “none”, “under maintenance”, or “out of order” is recorded in the first equipment field of the record found as above, the control part F110 determines that the first equipment is unusable in the facility at the destination location. If the information “usable” is recorded in the first equipment field of the record found as above, the control part F110 determines that the first equipment is usable in the facility at the destination location.

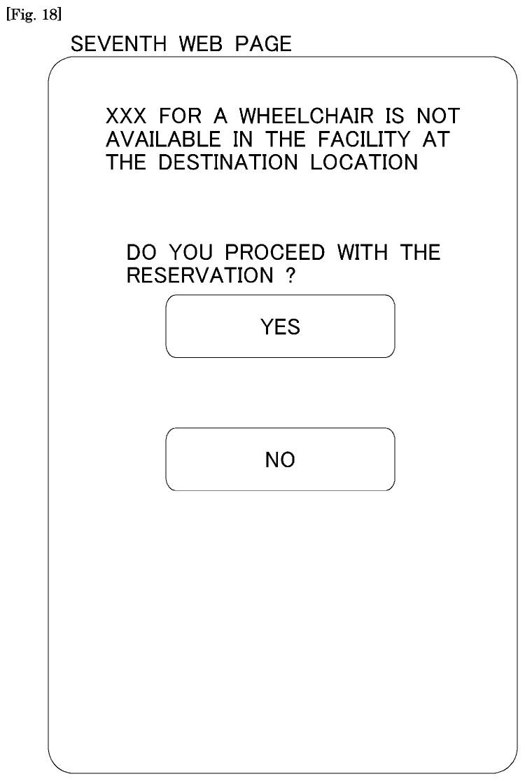

If it is determined that the first equipment is usable in the facility at the destination location of the first user, the control part F110 executes the processing of accepting the request for a ride in the same manner as in the above-described embodiment. If it is determined that the first equipment is not usable (or available) in the facility at the destination location of the first user, the control part F110 causes the browser of the first user's terminal 200A to display a web page informing that the first equipment is not usable in the facility at the destination location of the first user. This web page will also be referred to as the “seventh web page” hereinafter. FIG. 18 illustrates an example of the seventh web page displayed by the browser of the first user's terminal 200A. The seventh web page illustrated in FIG. 18 contains a message informing that the first equipment in the facility at the destination location is not usable, the “Yes” button, and the “No” button.

If the first user selects the “Yes” button on the seventh web page illustrated in FIG. 18 through the browser of the first user's terminal 200A, the control part F110 executes the processing of accepting the request for a ride in the same manner as in the above-described embodiment. If the first user selects the “No” button on the seventh web page illustrated in FIG. 18 through the browser of the first user's terminal 200A, the control part F110 terminates the processing of accepting the request for a ride.

(Process Executed in Server Apparatus)

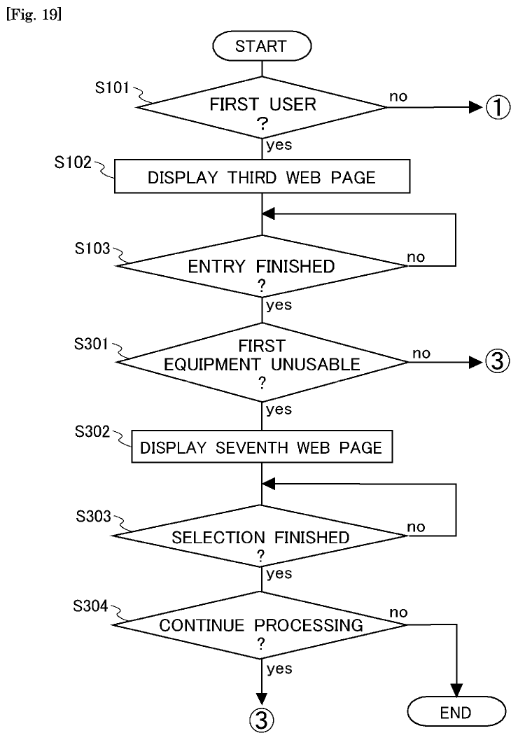

The process of determining the pick-up and drop-off locations of the user according to the modification will be described with reference to FIGS. 19 to 21. The processing steps in the flow charts of FIGS. 19 to 21 that are the same as those in the flow charts of FIGS. 13 and 14 are denoted by the same reference signs.

The difference between the processing routine according to the flow charts of FIGS. 19 to 21 and the processing routine according to the flow charts of FIGS. 13 and 14 is that if step S103 is answered in the affirmative in the former routine, the processing of steps S301 to S304 is executed prior to the processing of step S104. The processing in this routine other than the processing of steps S301 to S304 is the same as that in the routine according to FIGS. 13 and 14 and will not be described further.

In step S301, the control part F110 determines whether the first equipment is unusable in the facility at the destination location based on the destination location entered in step S103. Specifically, the control part F110 accesses the facility information database D150 using the name of the facility at the destination location or the address of the destination location entered in step S103 as an argument to find the record corresponding to the facility. If the information “none”, “under maintenance”, or “out of order” is recorded in the first equipment field of the record thus found, the control part F110 determines that the first equipment is unusable in the facility at the destination location (affirmative answer in step S301). If the information “usable” is recorded in the first equipment field of the record thus found, the control part F110 determines that the first equipment is usable in the facility at the destination location (negative answer in step S301).

If step S301 is answered in the affirmative, the control part F110 executes the processing of step S302 next. In step S302, the control part F110 causes the browser of the first user's terminal 200A to display the seventh web page (illustrated in FIG. 18) for informing that the first equipment is unusable in the facility at the destination location. After completing the processing of step S302, the control part F110 executes the processing of step S303 next.

In step S303, the control part F110 determines whether the first user has finished selecting the “Yes” button or the “No” button. If the first user has not finished selecting the “Yes” button or the “No” button (negative answer in step S303), the control part F110 waits until the first user finishes selecting the “Yes” button or the “No” button. If the first user has finished selecting the “Yes” button or the “No” button (affirmative answer in step S303), the control part F110 executes the processing of step S304 next.

In step S304, the control part F110 determines whether or not to continue the processing of accepting the request for a ride based on the result of the first user's selection in step S303. If the first user has selected the “Yes” button in step S303, the control part F110 determines to continue the processing of accepting the request for a ride (affirmative answer in step S304). If the first user has selected the “No” button in step S303, the control part F110 determines not to continue the processing of accepting the request for a ride (negative answer in step S304).

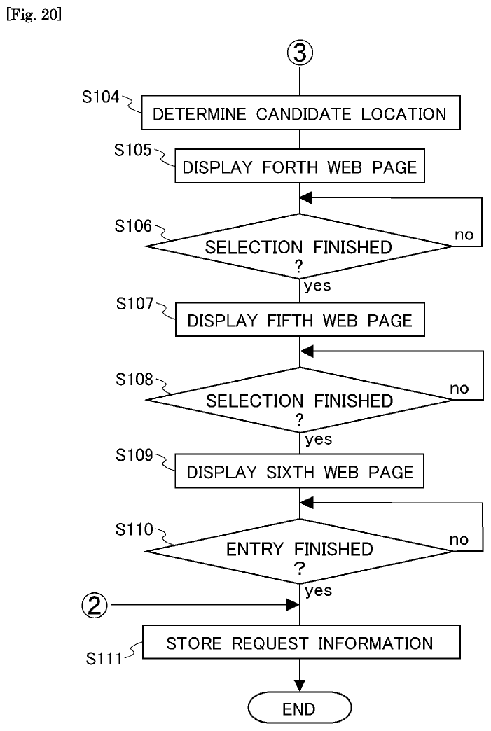

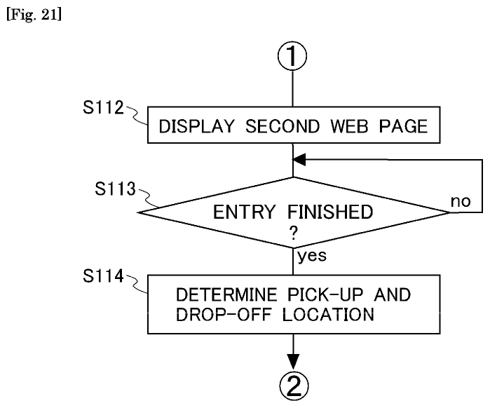

If step S304 is answered in the affirmative, the control part F110 executes the processing routine according to the flow charts of FIGS. 20 and 21. If step S304 is answered in the negative, the control part F110 stops the processing of accepting the request for a ride to terminate the execution of the processing routine according to the flow charts of FIGS. 19 to 21.

When the first user makes a request for a ride on the on-demand bus 1, the system according to the modification enables the first user to know whether the first equipment is usable (or available) in the facility at the destination location. This can prevent the first user from going to the facility at the destination place without knowing the fact that the first equipment is unusable (or unavailable). This can further improve the convenience of the first user when using the on-demand bus 1.

### <Others>

The above embodiment and its modification have been described only by way of example. The technology disclosed herein can be implemented in modified manners without departing from the essence of this disclosure. Processing and features that have been described in the above description of the embodiment and its modification may be employed in any combination so long as it is technically feasible to do so.

One or some of the processes that have been described as processes performed by one apparatus may be performed by a plurality of apparatuses in a distributed manner. One or some of the processes that have been described as processes performed by different apparatuses may be performed by one apparatus. For example, the processing executed in the server apparatus 100 may be partly executed by another apparatus connected with the server apparatus 100 through the network N1. The hardware configuration employed to implement various functions in a computer system may be modified flexibly.

The technology disclosed herein can be implemented by supplying a computer program(s) that implements the functions described in the above description of the embodiment to the server apparatus 100 to cause one or more processors of the server apparatus 100 to read out and execute the program(s). Such a computer program(s) may be supplied to the server apparatus 100 by a non-transitory, computer-readable storage medium that can be connected to a system bus of the apparatus, or through a network. The non-transitory, computer-readable storage medium is a recording medium that can store information such as data and programs electrically, magnetically, optically, mechanically, or chemically in a computer-readable manner. Examples of such a recording medium include any type of discs including magnetic discs, such as a floppy disc (registered trademark) and a hard disk drive (HDD), and optical discs, such as a CD-ROM, a DVD, and a Blu-ray disc. The recording medium may also be a read-only memory (ROM), a random access memory (RAM), an EPROM, an EEPROM, a magnetic card, a flash memory, an optical card, a solid state drive (SSD), or other medium.

What is claimed is:

1. An information processing apparatus comprising a controller including at least one processor, the controller being configured to create an operation plan for an on-demand bus in which the stop time length at a first pick-up and drop-off location at which a first user in a wheelchair is to be picked up or dropped off is set longer than the stop time length at a second pick-up and drop-off location at which a user other than the first user is to be picked up or dropped off.

2. The information processing apparatus according to claim 1, wherein the controller is configured to execute the following processing, when determining the first pick-up and drop-off location:
obtaining information on a starting location and a destination location of the first user;
determining at least one candidate location for the first pick-up and drop-off location based on the starting location and the destination location; and
causing a first user's terminal used by the first user to display first information related to the candidate location.

3. The information processing apparatus according to claim 2, wherein the controller is configured to further execute the processing of:
receiving information on the candidate location selected by the first user from the first user's terminal; and
determining the candidate location selected by the first user as the first pick-up and drop-off location.

4. The information processing apparatus according to claim 2, wherein the candidate location includes a candidate location for the pick-up location that is located within a predetermined distance from the starting location and for which the slope of the path from the starting location to the candidate location does not exceed a threshold value and a candidate location for the drop-off location that is located within a predetermined distance from the destination location and for which the slope of the path from the candidate location to the destination location does not exceed the threshold value.

5. The information processing apparatus according to claim 2, wherein the candidate location includes a candidate location for the pick-up location that is located within a predetermined distance from the starting location and has a space where a person in a wheelchair can wait.

6. The information processing apparatus according to claim 2, wherein the candidate location includes a candidate location for the pick-up location that is located within a predetermined distance from the starting location and has a roof and a candidate location for the drop-off location that is located within a predetermined distance from the destination location and has a roof.

7. The information processing apparatus according to claim 2, wherein the first information includes information on a route between the starting location and the candidate location for the pick-up location, information on the slope of a road on the route between the starting location and the candidate location for the pick-up location, information on a route between the destination location and the candidate location for the drop-off location, and information on the slope of a road on the route between the destination location and the candidate location for the drop-off location.

8. The information processing apparatus according to claim 7, wherein the first information further includes information on whether there is a roof at the candidate locations.

9. The information processing apparatus according to claim 2, wherein the controller is configured to further execute the following processing after obtaining the information on the starting location and the destination location:
determining whether first equipment for a wheelchair is usable in a facility located at the destination location; and
if it is determined that the first equipment is not usable, causing the first user's terminal to display information indicating that the first equipment is not usable.

10. The information processing apparatus according to claim 9, wherein the controller is configured to determine that the first equipment is not usable, if the first equipment is not provided in the facility at the destination location.

11. The information processing apparatus according to claim 9, wherein the controller is configured to determine that the first equipment is not usable, if the first equipment provided in the facility at the destination location is under maintenance.

12. The information processing apparatus according to claim 9, further comprising a memory storing information on whether or not each of a plurality of facilities located in the operation area of the on-demand bus has the first equipment and information related to maintenance of the first equipment in each of the facilities, wherein the controller is configured to determine whether the first equipment is usable based on the destination location of the first user and the information stored in the memory.

13. The information processing apparatus according to claim 9, wherein the first equipment is a slope for a wheelchair.

14. The information processing apparatus according to claim 9, wherein the first equipment is an elevator for a wheelchair.

15. The information processing apparatus according to claim 9, wherein the first equipment is a toilet for a person in a wheelchair.

16. The information processing apparatus according to claim 1, wherein the on-demand bus is a vehicle that travels autonomously by autonomous driving, and the controller is configured to transmit a command to travel according to the created operation plan to a terminal provided on the on-demand bus.

17. An information processing method comprising creating, by a computer, an operation plan for an on-demand bus in which the stop time length at a first pick-up and drop-off location at which a first user in a wheelchair is to be picked up or dropped off is set longer than the stop time length at a second pick-up and drop-off location at which a user other than the first user is to be picked up or dropped off.

18. The information processing method according to claim 17, wherein the computer executes the following processing, when determining the first pick-up and drop-off location:
obtaining information on a starting location and a destination location of the first user;
determining at least one candidate location for the first pick-up and drop-off location based on the starting location and the destination location; and
causing a first user's terminal used by the first user to display first information related to the candidate location.

19. The information processing method according to claim 18, wherein the computer further executes the processing of:
receiving information on the candidate location selected by the first user from the first user's terminal; and
determining the candidate location selected by the first user as the first pick-up and drop-off location.

20. The information processing method according to claim 18, wherein the candidate location includes a candidate location for the pick-up location that is located within a predetermined distance from the starting location and for which the slope of the path from the starting location to the candidate location does not exceed a threshold value and a candidate location for the drop-off location that is located within a predetermined distance from the destination location and for which the slope of the path from the candidate location to the destination location does not exceed the threshold value.
